(19) United States
(12) Patent Application Publication
(10) Pub. No.: US 2024/0342929 A1
(43) Pub. Date: Oct. 17, 2024

(54) ROBOT HAND

(71) Applicant: Industry-University Cooperation Foundation Hanyang University Erica Campus, Ansan-si (KR)

(72) Inventors: Woo Seok RYU, Seoul (KR); Byung Ju YI, Siheung-si (KR); Ji Yeong LEE, Seoul (KR); Sung On LEE, Seongnam-si (KR)

(21) Appl. No.: 18/754,168

(22) Filed: Jun. 26, 2024

Related U.S. Application Data
(63) Continuation of application No. PCT/KR2022/021452, filed on Dec. 28, 2022.

(30) Foreign Application Priority Data
Dec. 29, 2021 (KR) 10-2021-0191063

(51) Int. Cl. B25J 15/10

(52) U.S. Cl. CPC B25J 15/10

(57) ABSTRACT

Provided is a robot hand. The robot hand may comprise: a palm module that provides a base surface; a first finger module provided on one side of the palm module so as to be able to change position on the palm module; a second finger module provided on the other side of the palm module so as to be able to change position on the palm module; a plurality of third finger modules provided on the palm module and fixed in one direction between the first finger module and the second finger module; and a first linkage part connecting the palm module and the first finger module. The first linkage part can guide the first finger module to a target position without interfering with the palm module when the position of the first finger module changes on the palm module.

### TECHNICAL FIELD

The present invention relates to a robot hand, and more specifically, a robot hand capable of changing a position of a finger module according to a gripping object to provide the most stable and effective solution according to the object.

### BACKGROUND ART

In the robot hands according to the related art, positions of a ring finger and a thumb are fixed in the case of a 4-finger robot hand, and positions of a little finger and a thumb are fixed in the case of a 5-finger robot hand. Accordingly, in the related art, there is an inconvenience in that a left-hand robot hand and a right-hand robot hand should be separately manufactured.

In addition, as described above, when the left-hand robot hand and the right-hand robot hand are different from each other, it is difficult to cope with problems such as failure in driving double arm robots, and there is an inefficient problem in developing a driving controller and a driving algorithm.

In this case, finger modules of the robot hand according to the related art all exhibit the same performance, and in this case, since formation positions of the finger modules are fixed, there is a problem in that force distribution for each finger module is not efficient at the time of gripping or tool work.

As described above, the inefficient distribution of the force of the high-degree-of-freedom robot hand according to the related art, which is developed for a multipurpose tool operation and a gripping operation, deteriorates the performance of the robot hand.

Accordingly, there is an urgent need for a robot hand capable of providing the most stable and efficient solution according to an object.

### DISCLOSURE

### Technical Problem

On technical problem to be solved by the present invention is to provide a robot hand capable of changing a position of a finger module according to a gripping object to provide the most stable and effective solution according to the object.

The technical problems to be solved by the present invention are not limited to those described above.

### Technical Solution

In order to solve the technical problems, the present invention provides a robot hand.

According to one embodiment, the robot hand may include: a palm module configured to provide a base surface; a first finger module provided on one side of the palm module such that a position thereof is changeable on the palm module; a second finger module provided on the other side of the palm module such that a position thereof is changeable on the palm module; a plurality of third finger modules provided on the palm module and fixed in one direction between the first finger module and the second finger module; and a first linkage part configured to connect the palm module and the first finger module to each other, in which, when the position of the first finger module is changed on the palm module, the first linkage part may guide the first finger module to a target position without interfering with the palm module.

According to one embodiment, the robot hand may further include a first actuator module, in which the first actuator module may be mounted on each of the first to third finger modules to individually operate the first to third finger modules.

According to one embodiment, each of the first to third finger modules may have at least two joints in a longitudinal direction, and the first actuator module may be provided in a one-to-one correspondence with the at least two joints to directly operate each knuckle of the first to third finger modules about the joint.

According to one embodiment, the robot hand may further include a second actuator module, in which the second actuator module may be provided on the palm module, and the second actuator module may be connected to the first finger module through the first linkage part to provide a driving force to the first finger module such that the position of the first finger module is changed on the palm module.

According to one embodiment, the first actuator module, which is provided on one end of the first finger module in the longitudinal direction, may be disposed to face the second actuator module in a horizontal direction, the first linkage part may include: a first link in which one end thereof in the longitudinal direction is axially coupled to a lower driving shaft of the second actuator module, and the other end thereof in the longitudinal direction is hinge-coupled to a lower end of the first actuator module; and a second link in which one end thereof in the longitudinal direction is hinge-coupled to an upper frame of the palm module having the second actuator module provided under the palm module, and the other end thereof in the longitudinal direction is hinge-coupled to an upper end of the first actuator module, and a hinge shaft, to which the second link and the upper frame are hinge-coupled, and the driving shaft may not be coaxially aligned in a vertical direction.

According to one embodiment, the robot hand may further include a second linkage part, in which the second linkage part may guide the second finger module to a target position without interfering with the palm module when the position of the second finger module is changed on the palm module.

According to one embodiment, the robot hand may further include a third actuator module, in which the third actuator module may be provided on the palm module, and the third actuator module may be connected to the second finger module through the second linkage part to provide a driving force to the second finger module such that the position of the second finger module is changed on the palm module.

According to one embodiment, the second linkage part may include: a third link in which one end thereof in the longitudinal direction is axially coupled to a lower driving shaft of the third actuator module, and the other end thereof in the longitudinal direction is hinge-coupled to a lower end of the first actuator module; and a fourth link in which one end thereof in the longitudinal direction is hinge-coupled to an upper frame of the palm module having the third actuator module provided under the palm module, and the other end thereof in the longitudinal direction is hinge-coupled to an upper end of the first actuator module, and a hinge shaft, to which the fourth link and the upper frame are hinge-coupled, and the driving shaft may not be coaxially aligned in a vertical direction.

According to one embodiment, each of the first to third finger modules may include: a knuckle part configured to provide an installation space of the first actuator module; and a fingertip provided at an end of the knuckle part.

According to one embodiment, the robot hand may be switched to any one of a plurality of operation modes may be performed according to change in the positions of the first and second finger modules on the palm module.

According to one embodiment, the plurality of operation modes may include a left hand mode in which the first finger module serves as a thumb, a right hand mode in which the second finger module serves as a thumb, and a gripper mode in which the first finger module and the second finger module are positioned to face the third finger module.

### Advantageous Effects

According to the embodiment of the present invention, the robot hand may include: a palm module configured to provide a base surface; a first finger module provided on one side of the palm module such that a position thereof is changeable on the palm module; a second finger module provided on the other side of the palm module such that a position thereof is changeable on the palm module; a plurality of third finger modules provided on the palm module and fixed in one direction between the first finger module and the second finger module; and a first linkage part configured to connect the palm module and the first finger module to each other, in which, when the position of the first finger module is changed on the palm module, the first linkage part may guide the first finger module to a target position without interfering with the palm module.

Accordingly, it is possible to provide a robot hand capable of changing a position of the finger module according to a gripping object without interfering with the palm module on the finger module.

That is, according to the embodiment of the present invention, it is possible to move the finger module to a desired position without colliding with the palm module, and accordingly, it is possible to grip various objects, and it is possible to provide the most stable and efficient solution according to the gripping objects.

In other words, according to one embodiment of the present invention, it is possible to most effectively apply a force of the finger module to an object, and accordingly, it is possible to most stably grip the object.

According to one embodiment of the present invention, it is not necessary to separately manufacture a left-hand robot hand and a right-hand robot hand, which may be the greatest efficiency and advantage in utilizing and manufacturing the robot hand.

### DESCRIPTION OF DRAWINGS

FIG. 1 is a perspective view showing a robot hand according to one embodiment of the present invention.

FIGS. 2 and 3 are transparent views for explaining a first actuator of the robot hand according to one embodiment of the present invention.

FIG. 4 is a perspective view for explaining a first linkage part and a second linkage part of the robot hand according to one embodiment of the present invention.

FIG. 5 is a reference view for explaining the first linkage part and the second linkage part of the robot hand according to one embodiment of the present invention.

FIG. 6 is a partial perspective view showing the first linkage part according to one embodiment of the present invention.

FIG. 7 is a schematic view showing a left hand mode of the robot hand according to one embodiment of the present invention.

FIG. 8 is a schematic view showing a right hand mode of the robot hand according to one embodiment of the present invention.

FIG. 9 is a schematic view showing a gripper mode of the robot hand according to one embodiment of the present invention.

FIG. 10 is a schematic view showing a first transformation mode of the robot hand according to one embodiment of the present invention.

FIG. 11 is a schematic view showing a second transformation mode of the robot hand according to one embodiment of the present invention.

FIG. 12 is a schematic view showing a third transformation mode of the robot hand according to one embodiment of the present invention.

### MODE FOR INVENTION

Hereinafter, preferred embodiments of the present invention will be described in detail with reference to the accompanying drawings. However, the present invention may be embodied in different forms and should not be construed as limited to the embodiments set forth herein. Rather, the embodiments are provided so that this disclosure will be thorough and complete, and will fully convey the scope of the present invention to those skilled in the art.

In the present specification, it will be understood that when an element is referred to as being “on” another element, it can be formed directly on the other element or intervening elements may be present. In addition, in the drawings, the shapes and the sizes are exaggerated for effective explanation of the technical content.

In addition, it will be also understood that although the terms first, second, third, etc. may be used herein to describe various elements, these elements should not be limited by these terms. These terms are only used to distinguish one element from another element. Thus, a first element in some embodiments may be termed a second element in other embodiments without departing from the teachings of the present invention. Embodiments explained and illustrated herein include their complementary counterparts. As used herein, the term “and/or” includes any and all combinations of one or more of the associated listed elements.

The singular expression also includes the plural meaning as long as it does not differently mean in the context. In addition, the terms “comprise”, “have” etc., of the description are used to indicate that there are features, numbers, steps, elements, or combinations thereof, and they should not exclude the possibilities of combination or addition of one or more features, numbers, operations, elements, or a combination thereof. Furthermore, it will be understood that when an element is referred to as being “connected” or “coupled” to another element, it may be directly connected or coupled to the other element or intervening elements may be present.

In addition, when detailed descriptions of related known functions or constitutions are considered to unnecessarily cloud the gist of the present invention in describing the present invention below, the detailed descriptions will not be included.

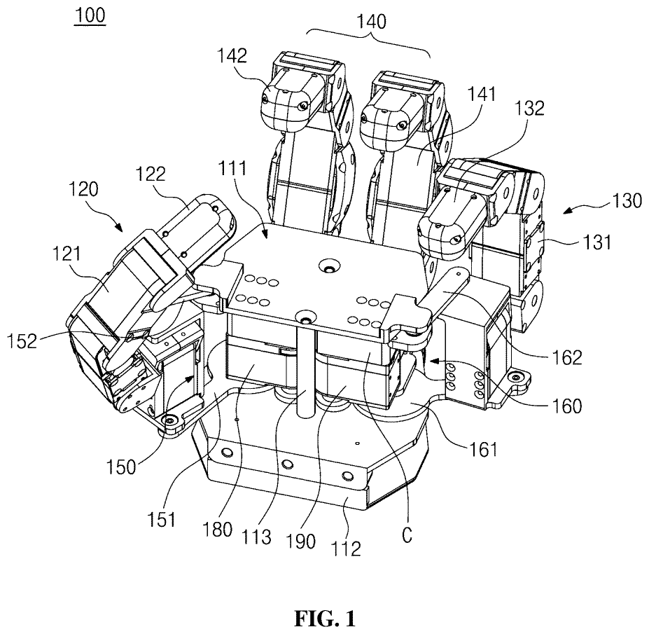

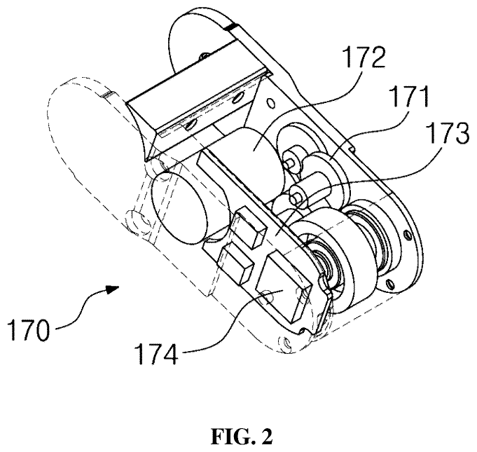

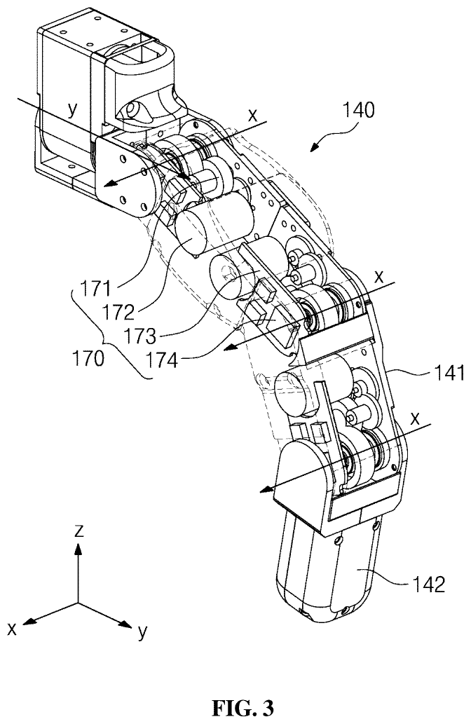

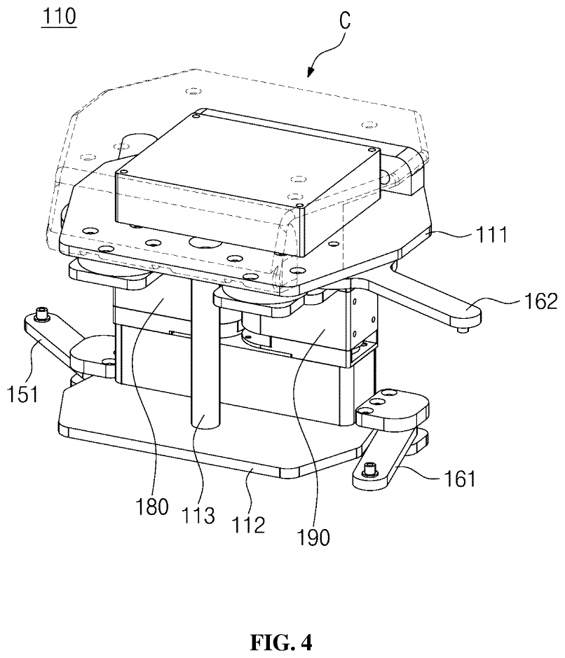

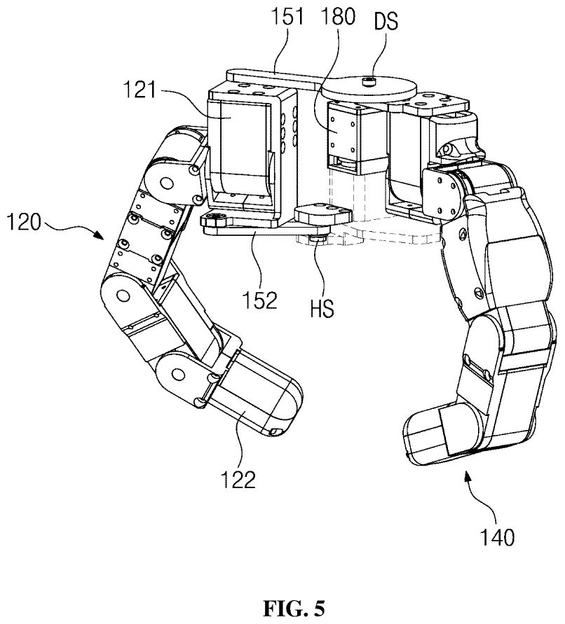

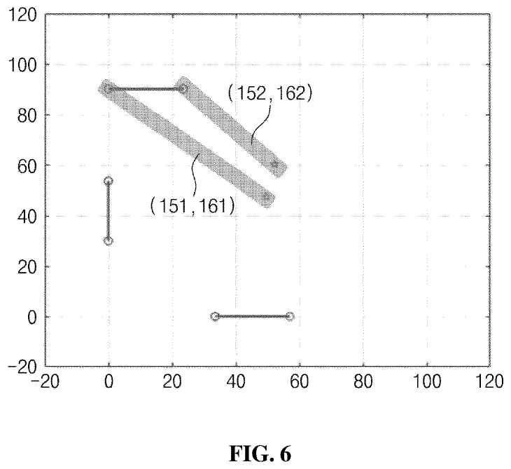

FIG. 1 is a perspective view showing a a robot hand according to one embodiment of the present invention, FIGS. 2 and 3 are transparent views for explaining a first actuator of the robot hand according to one embodiment of the present invention, FIG. 4 is a perspective view for explaining a first linkage part and a second linkage part of the robot hand according to one embodiment of the present invention, FIG. 5 is a reference view for explaining the first linkage part and the second linkage part of the robot hand according to one embodiment of the present invention, and FIG. 6 is a partial perspective view showing the first linkage part according to one embodiment of the present invention.

As shown in FIG. 1, a robot hand 100 according to one embodiment of the present invention may be formed by including a palm module 110, a first finger module 120, a second finger module 130, a third finger module 140, and a first linkage part 150.

The finger module 110 may provide a base surface for the first finger module 120, the second finger module 130, and the third finger module 140, that is, a palm surface. The palm module 110 may be connected to the first finger module 120, the second finger module 130, the third finger module 140, and the first linkage part 150, and may support the same.

In addition, the palm module 110 may provide a mounting surface of a second actuator module 180, a third actuator module 190, and an integrated controller C, which will be described below.

According to one embodiment of the present invention, the palm module 110 may include an upper frame 111, a lower frame 112, and a support 113.

The upper frame 111 may be provided in the form of a plate. The lower frame may be provided below the upper frame 111 to face the upper frame 111.

In this case, since the lower frame 112 supports all the upper frame 111 and the first finger module 120, the second finger module 130, and the third finger module 140 connected to the upper frame 111, the lower frame 112 is preferably formed to have a weight and a size capable of supporting the upper frame 111, the first finger module 120, the second finger module 130, and the third finger module 140.

Further, the support 113 may be connected between the upper frame 111 and the lower frame 112. The support 113 may separate the upper end frame 111 above the lower frame 112. The support 113 may be provided in a bar or rod shape extending in one direction. A pair of supports 113 are provided so as to be vertically connected to both sides of the upper frame 111 and the lower frame 112 in a width direction.

As described above, a space between the upper frame 111 and the lower frame 112 separated by the support 113 may be provided as the mounting space for the second actuator module 180, the third actuator module 190, and the integrated controller C.

The first finger module 120 may be provided on one side of the palm module 110. Specifically, the first finger module 120 may be provided upward at one edge of the finger module 110 through the first linkage part 150.

According to one embodiment of the present invention, the first finger module 120 may include a knuckle part 121 and a fingertip 122.

The first finger module 120 may include at least one knuckle part 121 connected in one direction. For example, the first finger module 120 may include one knuckle part 120.

When the first finger module 120 includes one knuckle part 121, a lower end of the knuckle part 121 in a longitudinal direction may be joint-coupled to the palm module 110, and an upper end of the knuckle part 121 in the longitudinal direction may be joint-coupled to the fingertip 122. Accordingly, the first finger module 120 may have two joints in the longitudinal direction.

In this case, it is merely an example that the first finger module 120 includes one knuckle part 121, and obviously, the first finger module 120 may include two or more knuckle parts 121. When the first finger module 120 includes one knuckle part 121, the first finger module 120 may serve as a thumb.

Meanwhile, referring to FIGS. 2 and 3, the robot hand 100 according to one embodiment of the present invention may further include a first actuator module 170. The first actuator module 170 may be mounted in an installation space provided inside the knuckle part 121.

The first actuator module 170 may be mounted on the first finger module 120 to operate the first finger module 120. The operation of the first actuator module 170 may be controlled by the integrated controller C (FIG. 6) installed on a side of the palm module 110.

According to one embodiment of the present invention, as the first finger module 120 has two joints, the first actuator module 170 may be provided in a one-to-one correspondence with two joints so as to directly operate the knuckle part 121 connected to the first finger module 120 about the joint.

In order to directly operate the knuckle part 121 connected to the first finger module 120 about the joint, the first actuator module 170 may include a decelerator 171, a motor 172, an encoder 173, and a motor drive 174.

Since the decelerator 171, the motor 172, the encoder 173, and the motor drive 174, which rotate the knuckle part 121 about the joint, are operated according to a general driving mechanism, a detailed description thereof will be omitted.

Meanwhile, the fingertip 122 may be joint-coupled to the distalmost knuckle part 121. The fingertip 122 may interwork with the distalmost knuckle part 121 when the distalmost knuckle part 121 rotates by the first actuator module 170. In this case, the fingertip 122 may be connected to the separate first actuator module 170, and thus may be independently operated without interworking with the distalmost knuckle part 121.

Referring back to FIG. 1, according to one embodiment of the present invention, the first finger module 120 may be provided such that a position thereof on the palm module 110 may be changed. Thus, the first finger module 120 may further have one additional degree of freedom in addition to the degree of freedom according to the joint.

To this end, the robot hand 100 according to one embodiment of the present invention may further include the second actuator module 180.

The second finger module 180 may be provided on the palm module 110. Specifically, the second actuator module 180 may be mounted in the space of the palm module 110 between the upper frame 111 and the lower frame 112.

The second actuator module 180 may be connected to the first finger module 120 through the first linkage part 150. The second actuator module 180 connected to the first finger module 120 through the first linkage part 150 may provide a driving force to the first finger module 120 such that the position of the first finger module 120 is changed on the palm module 110.

Accordingly, the first finger module 120 may move to a predetermined target position on the palm module 110.

The operation of the second actuator module 180 may be controlled by the integrated controller C (FIG. 6) installed on a side of the palm module 110.

The second finger module 130 may be provided on the other side of the palm module 110. Specifically, the second finger module 130 may be provided upward at the other edge of the finger module 110 through a second linkage part 160 to be described below.

For example, when the first finger module 120 serves as a thumb, the second finger module 130 may serve as a little finger. In this case, according to one embodiment of the present invention, the first finger module 120 and the second finger module 130 may be provided such that positions thereof may be changed on the palm module 110.

Accordingly, the roles of the first finger module 120 and the second finger module 130 may be changed for each situation, which will be described in more detail below.

According to one embodiment of the present invention, the second finger module 130 may include a knuckle part 131 and a fingertip 132.

The second finger module 130 may include at least one knuckle part 131 connected in one direction. For example, the second finger module 130 may include one knuckle part 131.

When the second finger module 130 includes one knuckle part 131, a lower end of the knuckle part 131 in a longitudinal direction may be joint-coupled to the palm module 110, and an upper end of the knuckle part 121 in the longitudinal direction may be joint-coupled to the fingertip 132. Accordingly, the second finger module 130 may have two joints in the longitudinal direction.

In this case, it is merely an example that the second finger module 130 includes one knuckle part 131, and obviously, the second finger module 130 may include two or more knuckle parts 131.

The first actuator module 170 may be installed in an installation space provided inside the knuckle part 131 to operate the knuckle part 131.

According to one embodiment of the present invention, as the second finger module 130 has two joints, the first actuator module 170 may be provided in a one-to-one correspondence with two joints so as to directly operate the knuckle part 131 connected to the second finger module 130 about the joint.

Meanwhile, the fingertip 132 may be joint-coupled to the distalmost knuckle part 131. The fingertip 132 may interwork with the distalmost knuckle part 131 when the distalmost knuckle part 121 rotates by the first actuator module 170. In this case, the fingertip 132 may be connected to the separate first actuator module 170, and thus may be independently operated without interworking with the distalmost knuckle part 131.

According to one embodiment of the present invention, the second finger module 130 and the first finger module 120 may be provided such that positions thereof on the palm module 110 may be changed. Thus, the second finger module 130 may further have one additional degree of freedom in addition to the degree of freedom according to the joint.

To this end, the robot hand 100 according to one embodiment of the present invention may further include the third actuator module 190.

The third finger module 190 may be provided on one side of the palm module 110. Specifically, the third actuator module 190 may be mounted in the space of the palm module 110 between the upper frame 111 and the lower frame 112. In this case, the third actuator module 190 may be mounted in parallel to the second actuator module 180 in a horizontal direction.

The third actuator module 190 may be connected to the second finger module 130 through the second linkage part 160 to be described below. The third actuator module 190 connected to the second finger module 130 through the second linkage part 160 may provide a driving force to the second finger module 130 such that the position of the second finger module 130 is changed on the palm module 110.

Accordingly, the second finger module 130 may move to a predetermined target position on the palm module 110. For example, the second finger module 130 may move to the predetermined target position on the palm module 110 and may be disposed to face the first finger module 130 or may be disposed in parallel to the first finger module 130 in one direction.

The operation of the third actuator module 190 may be controlled by the integrated controller C (FIG. 6) installed on a side of the palm module 110. That is, according to one embodiment of the present invention, the integrated controller C may integrally control the first actuator module 170, the second actuator 180, and the third actuator module 190.

The third finger module 140 may be provided on the palm module 110. In this case, a plurality of third finger modules 140 may be provided. The plurality of third finger modules 140 may be fixed between the first finger module 120 and the second finger module 130 in one direction.

That is, according to one embodiment of the present invention, unlike the first finger module 120 and the second finger module 130 in which positions thereof are changed on the palm module 110, a position of the third finger module 140 may be fixed onto the palm module 11.

As described above, when two third finger modules 140 fixed in one direction are provided, the two finger modules 140 may serve as an index finger and a middle finger, respectively, and when three third finger modules 140 are provided, the three third finger modules 140 may serve as an index finger, a middle finger, and a ring fingers, respectively.

According to one embodiment of the present invention, the third finger module 140 may include a knuckle part 141 and a fingertip 142.

The third finger module 140 may include at least one knuckle part 141 connected in one direction. For example, the third finger module 140 may include two knuckle parts 141 connected in one direction.

When the third finger module 140 includes two knuckle parts 141, one of the knuckle part 141 may be joint-coupled to the palm module 110, the other knuckle part 141 may be joint-coupled to the fingertip 142, and the one knuckle part 141 and the other knuckle part 141 may also be joint-coupled to each other. Accordingly, the third finger module 140 may have three joints in the longitudinal direction.

In this case, it is merely an example that the third finger module 140 includes two knuckle parts 141, and obviously, the third finger module 140 may include one knuckle part 141 or three or more knuckle parts 141.

The first actuator module 170 may be installed in an installation space provided inside the knuckle part 141 to operate the knuckle part 141.

According to one embodiment of the present invention, as the third finger module 140 has three joints, the first actuator module 170 may be provided in a one-to-one correspondence with three joints so as to directly operate the knuckle part 141 connected to the third finger module 140 about the joint.

Referring to FIG. 3, the first actuator module 170 may rotate each knuckle part 141 of the third finger module 140 about an x-axis. In this case, the first actuator module 170, which is provided on the knuckle part 141 adjacent to the palm module 110, may rotate the knuckle part 141 about the x-axis as well as about a y-axis.

Accordingly, the entire third finger module 140 may rotate in a left-right direction (based on FIG. 3) about the y-axis. That is, the third finger module 140 having three joints in the longitudinal direction may have four degrees of freedom.

As described above, the first actuator module 170 may be mounted on each of the first finger module 120, the second finger module 130, and the third finger module 140 to individually operate the finger modules 120, 130, and 140, and a plurality of first actuator modules 170 may also individually operate the knuckle parts 121, 131, and 141 of the finger modules 120, 130, and 140.

Meanwhile, the fingertip 142 may be joint-coupled to the distalmost knuckle part 141. The fingertip 142 may interwork with the distalmost knuckle part 141 when the distalmost knuckle part 121 rotates by the first actuator module 170. In this case, the fingertip 142 may be connected to the separate first actuator module 170, and thus may be independently operated without interworking with the distalmost knuckle part 141.

Referring back to FIG. 1, the first linkage part 150 may connect the first finger module 120 and the palm module 110 to each other. According to one embodiment of the present invention, when the position of the first finger module 120 is changed on the palm module 110, that is, when the first finger module 120 moves on the palm module 110 by the second actuator module 180, the first linkage portion 150 may guide the first finger module 120 to the target position without interfering with the palm module 110.

Referring to FIGS. 4 and 5, the first linkage part 150 may include a first link 151 and a second link 152.

One end of the first link 151 in the longitudinal direction may be axially coupled to a lower driving shaft DS of the second actuator module 180 and the other end of the first link 151 in the longitudinal direction may be hinge-coupled to a lower end of the first actuator module 170.

In this case, the first actuator module 170 may be any one first actuator module 170 that is provided on one end of the first finger module 120 in the longitudinal direction so as to face the second actuator module 180 in the horizontal direction, among the first actuator modules 170 mounted on the first finger module 120.

Therefore, the driving force of the second actuator module 180 may be transmitted to the first finger module 120 through the first link 151, and accordingly, the first finger module 120 may move such that the position thereof is changed on the palm module 110.

One end of the second link 152 in the longitudinal direction may be hinge-coupled to the upper frame 111 of the palm module 110 having the second actuator module 180 provided under the palm module 110, and the other end of the second link 152 in the longitudinal direction may be hinge-coupled to an upper end of the first actuator module 170.

In this case, according to one embodiment of the present invention, the driving shaft DS of the second actuator module 180, to which one end of the first link 151 in the longitudinal direction is axially coupled, and a hinge shaft HS, to which the one end of the second link 152 in the longitudinal direction and the upper frame 111 are hinge-coupled, may not be coaxially aligned in the vertical direction.

Similarly, the hinge shaft HS, to which the lower end of the first actuator module 170 and the other end of the first link 151 in the longitudinal direction are hinge-coupled, and the hinge shaft HS, to which the upper end of the first actuator module 170 and the other end of the second link 152 in the longitudinal direction are hinge-coupled, may also not be coaxially aligned in the vertical direction.

As shown in FIG. 6, the positions of the first finger module may be set to (three to five) positions where a designer wants to move the first finger module, and the positions are incorporated, so that the first finger module may pass through the three (and four to five) set positions only by a 1-degree-of-freedom motor (a motor provided in the second actuator module) according to the movement of one first linkage part.

According to one embodiment of the present invention, through the pre-design for the first linkage part, the axes facing each other in the vertical direction are not coaxially aligned as described above, that is, the first link 151 (on the graph) and the second link 152 (on the graph) do not overlap each other in the vertical direction. Accordingly, when the driving force generated by the second actuator module is transmitted to the first finger module through the first linkage part, the first finger module reaches a desired target position without colliding with the palm module.

Meanwhile, the robot hand 100 according to one embodiment of the present invention may further include the second linkage part 160. The second linkage part 160 may connect the palm module 110 and the second finger module 130 to each other.

According to one embodiment of the present invention, when the position of the second finger module 130 is changed on the palm module 110, that is, when the second finger module 130 moves on the palm module 110 by the third actuator module 190, the second linkage portion 160 may guide the second finger module 130 to the target position without interfering with the palm module 110.

Referring back to FIG. 4, the second linkage part 160 may include a third link 161 and a fourth link 162.

One end of the third link 161 in the longitudinal direction may be axially coupled to a lower driving shaft DS of the third actuator module 190 and the other end of the third link 161 in the longitudinal direction may be hinge-coupled to the lower end of the first actuator module 170.

In this case, the first actuator module 170 may be any one first actuator module 170 that is provided on one end of the second finger module 130 in the longitudinal direction so as to face the third actuator module 190 in the horizontal direction, among the first actuator modules 170 mounted on the second finger module 130.

Therefore, the driving force of the third actuator module 190 may be transmitted to the second finger module 130 through the third link 161, and accordingly, the second finger module 130 may move such that the position thereof is changed on the palm module 110.

One end of the fourth link 162 in the longitudinal direction may be hinge-coupled to the upper frame 111 of the palm module 110 having the third actuator module 190 provided under the palm module 110, and the other end of the fourth link 162 in the longitudinal direction may be hinge-coupled to the upper end of the first actuator module 170.

In this case, according to one embodiment of the present invention, the driving shaft DS of the third actuator module 190, to which one end of the third link 161 in the longitudinal direction is axially coupled, and a hinge shaft HS, to which the one end of the fourth link 162 in the longitudinal direction and the upper frame 111 are hinge-coupled, may not be coaxially aligned in the vertical direction.

Similarly, the hinge shaft HS, to which the lower end of the first actuator module 170 and the other end of the third link 161 in the longitudinal direction are hinge-coupled, and the hinge shaft HS, to which the upper end of the first actuator module 170 and the other end of the fourth link 162 in the longitudinal direction are hinge-coupled, may also not be coaxially aligned in the vertical direction.

Referring back to FIG. 6, the positions of the second finger module may be set to (three to five) positions where a designer wants to move the second finger module, and the positions are incorporated, so that the second finger module may pass through the three (and four to five) set positions only by a 1-degree-of-freedom motor (a motor provided in the third actuator module) through the movement of one second linkage part.

According to one embodiment of the present invention, through the pre-design for the second linkage part, the axes facing each other in the vertical direction are not coaxially aligned as described above, that is, the third link 161 (on the graph) and the fourth link 162 (on the graph) do not overlap each other in the vertical direction. Accordingly, when the driving force generated by the third actuator module is transmitted to the second finger module through the second linkage part, the second finger module reaches a desired target position without colliding with the palm module.

The robot hand 100 according to one embodiment of the present invention includes the first linkage part 150 and the second linkage part 160 as described above, the first finger module 120 or the second finger module 130 may move to a desired position (predetermined position) without colliding with the palm module 110 on the palm module 110.

Accordingly, the robot hand 100 may grip various objects and provide the most stable and efficient solution according to gripping objects. In other words, the robot hand 100 according to one embodiment of the present invention may most effectively apply a force of the first finger module 120, the second finger module 130, and the third finger module 140 to the objects, thereby most stably gripping the objects.

As described above, the robot hand 100 may independently and freely change the positions of the first finger module 120 and the second finger module 130, which are disposed at both edge sides thereof. Accordingly, it is not necessary to separately manufacture a left-hand robot hand and a right-hand robot hand, which may be the greatest efficiency and advantage in utilizing and manufacturing the robot hand.

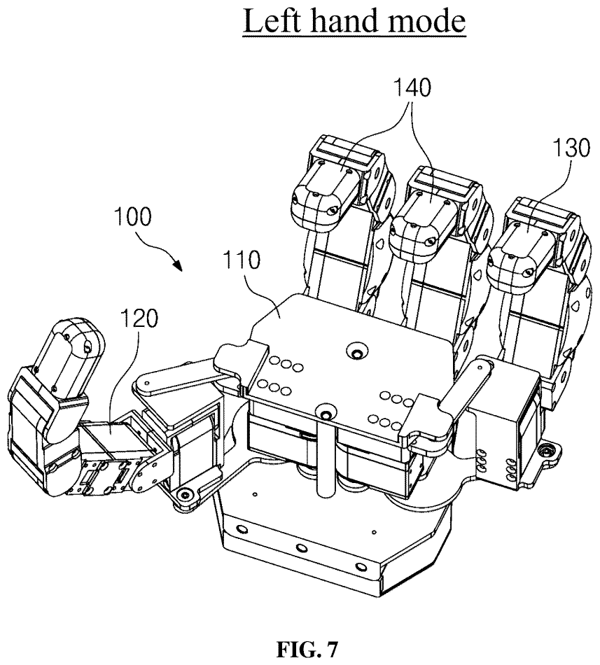

Hereinafter, various operation modes of the robot hand according to one embodiment of the present invention will be described with reference to FIGS. 7 to 12.

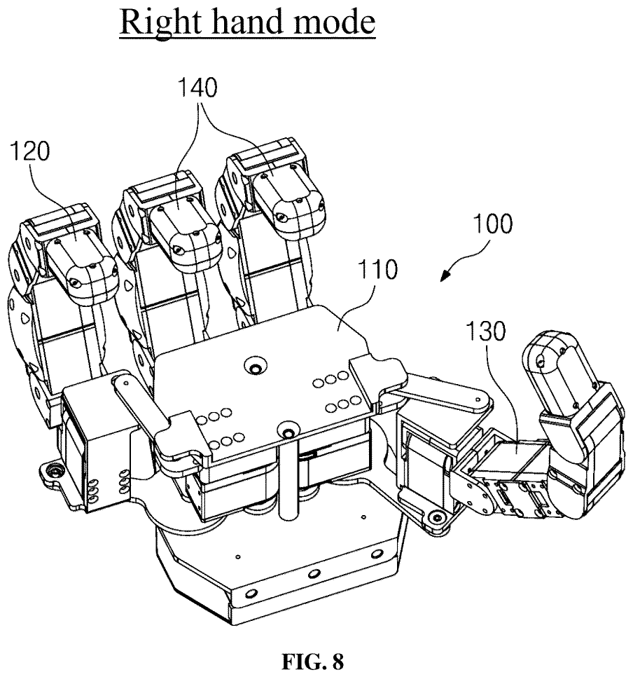

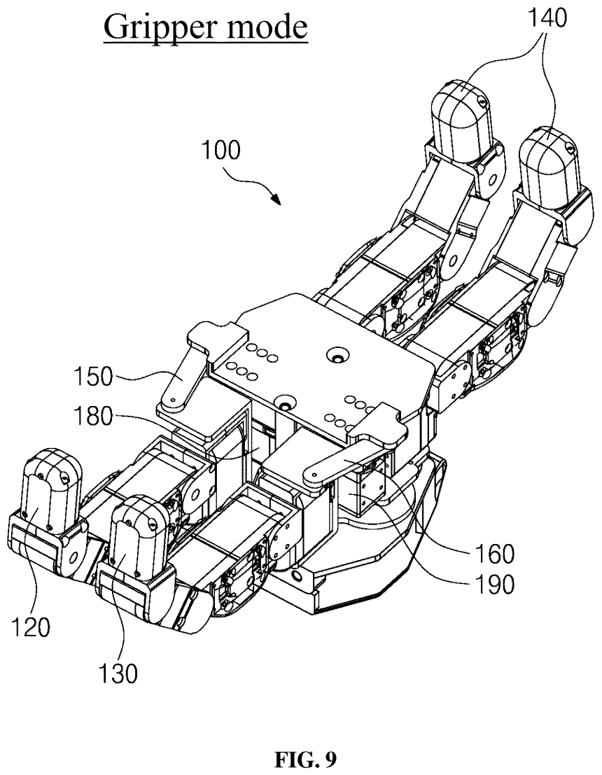

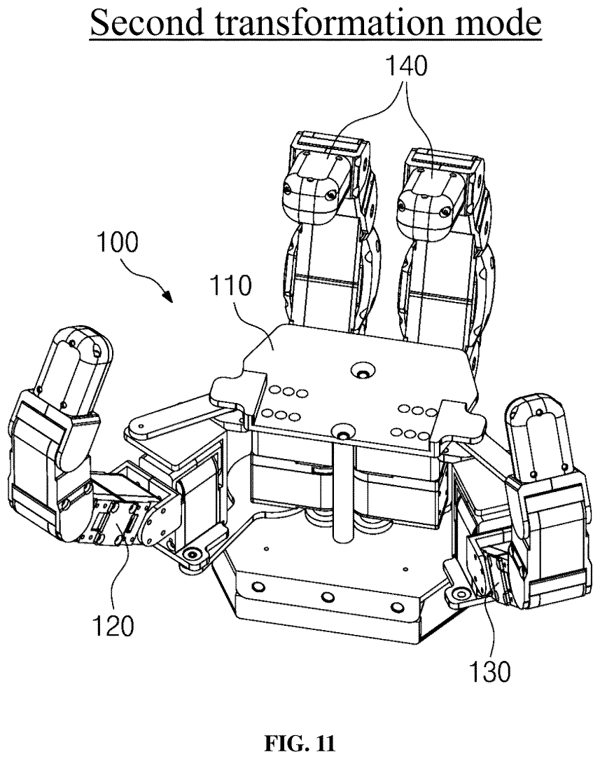

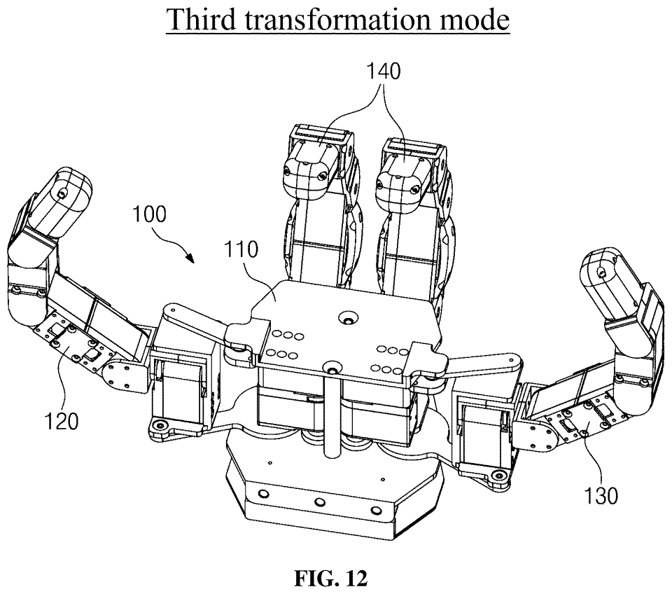

FIG. 7 is a schematic view showing a left hand mode of the robot hand according to one embodiment of the present invention, FIG. 8 is a schematic view showing a right hand mode of the robot hand according to one embodiment of the present invention, FIG. 9 is a schematic view showing a gripper mode of the robot hand according to one embodiment of the present invention, FIG. is a schematic view showing a first transformation mode of the robot hand according to one 10 embodiment of the present invention, FIG. 11 is a schematic view showing a second transformation mode of the robot hand according to one embodiment of the present invention, and FIG. 12 is a schematic view showing a third transformation mode of the robot hand according to one embodiment of the present invention.

The robot hand 100 according to one embodiment of the present invention may be switched to one of various operation modes by changing the position of the first finger module 120 on the palm module 110, changing the position of the second finger module 130, or simultaneously changing the positions of the first finger module 120 and the second finger module 130.

For example, the operation modes may include a left hand mode in which the first finger module 120 positioned at the leftmost position based on the drawings serves as a thumb, a right hand mode in which the second finger module 130 positioned at the rightmost position based the drawings serves as a thumb, and a gripper mode in which the first finger module 120 and the second finger module 130 are positioned to face the third finger module 140.

First, as shown in FIG. 7, when the first finger module 120 moves to the set position on the palm module 110 such that a gap between the first finger module 120 and the third finger module 140 are widened, the operation mode of the robot hand 100 according to one embodiment of the present invention may be switched to the left hand mode.

Accordingly, the first finger module 120 serves as a thumb. In this case, in the case of the left hand mode, the second finger module 130 may be positioned in parallel to the third finger module 140.

Further, as shown in FIG. 8, when the first finger module 120 moves such that the first finger module 120 is positioned in parallel to the third finger module 140 on the palm module 110, and the second finger module 130 positioned in parallel to the third finger module 140 moves to the set position to widen the gap between the third finger module 140 and the second finger module 130, the operation mode of the robot hand 100 according to one embodiment of the present invention may be switched from the left hand mode to the right hand mode. Accordingly, the second finger module 130 serves as a thumb.

The robot hand 100 according to one embodiment of the present invention may be freely switched from the left hand mode to the right hand mode or from the right hand mode to the left hand mode. Therefore, the robot hand 100 according to one embodiment of the present invention does not necessarily and separately manufacture a left-hand robot hand and a right-hand robot hand, which may be the greatest efficiency and advantage in utilizing and manufacturing the robot hand.

In addition, as shown in FIG. 9, when the first finger module 120 and the second finger module 130 simultaneously move on the palm module 110 such that the first finger module 120 and the second finger module 130 are positioned to face the third finger module 140, the operation mode of the robot hand 100 according to one embodiment of the present invention may be switched to the gripper mode.

The robot hand 100 according to one embodiment of the present invention may stably grip, for example, a circular object through the gripper mode.

Meanwhile, in addition to the left hand mode, the right hand mode, and the gripper mode, the robot hand 100 according to one embodiment of the present invention may be further switched to various operation modes in order to stably and effectively grip objects having various shapes or forms.

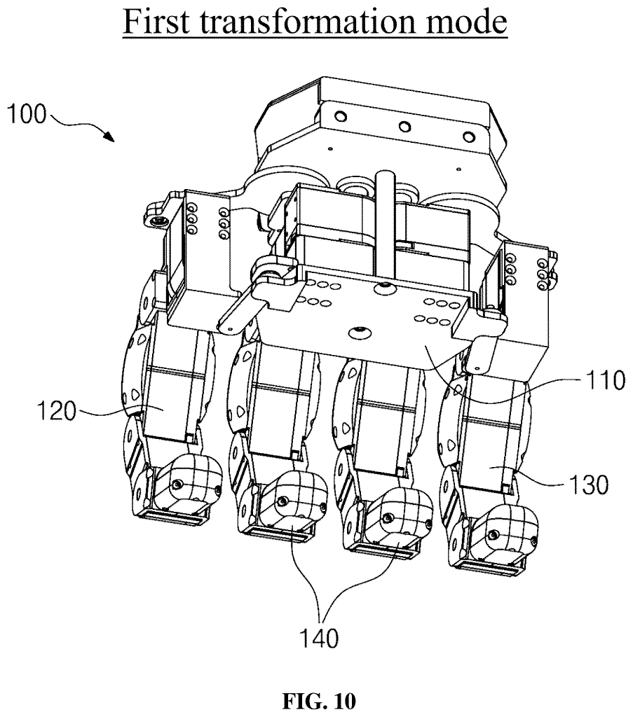

As shown in FIG. 10, when the first finger module 120 and the second finger module 130 move together on the palm module 110 such that the first finger module 120 and the second finger module 130 are aligned with the third finger module 140 in one direction, the operation mode of the robot hand 100 according to one embodiment of the present invention may be switched to a first transformation mode.

The robot hand 100 according to one embodiment of the present invention may grip a tool such as a hammer with the strongest force through the first transformation mode.

In addition, as shown in FIGS. 11 and 12, when the first finger module 120 moves to a first position or a second position on the palm module 110 to widen a gap between the third finger module 140 and the first finger module 120, and simultaneously, the second finger module 130 moves to the first position or the second position on the palm module 110 to widen a gap between the third finger module 140 and the second finger module 130, the robot hand 100 according to one embodiment of the present invention may be switched to a second transformation mode or a third transformation mode, so that a force may be effectively applied to various objects, thereby stably gripping various objects.

While the present invention has been described in connection with the embodiments, it is not to be limited thereto but will be defined by the appended claims. In addition, it is to be understood that those skilled in the art can substitute, change or modify the embodiments in various forms without departing from the scope and spirit of the present invention.

1. A robot hand comprising:
a palm module configured to provide a base surface;
a first finger module provided on one side of the palm module such that a position thereof is changeable on the palm module;
a second finger module provided on the other side of the palm module such that a position thereof is changeable on the palm module;
a plurality of third finger modules provided on the palm module and fixed in one direction between the first finger module and the second finger module; and
a first linkage part configured to connect the palm module and the first finger module to each other,
wherein, when the position of the first finger module is changed on the palm module, the first linkage part guides the first finger module to a target position without interfering with the palm module.

2. The robot hand of claim 1, further comprising a first actuator module,
wherein the first actuator module is mounted on each of the first to third finger modules to individually operate the first to third finger modules.

3. The robot hand of claim 2, wherein each of the first to third finger modules has at least two joints in a longitudinal direction, and
the first actuator module is provided in a one-to-one correspondence with the at least two joints to directly operate each knuckle of the first to third finger modules about the joint.

4. The robot hand of claim 2, further comprising a second actuator module,
wherein the second actuator module is provided on the palm module, and
the second actuator module is connected to the first finger module through the first linkage part so as to provide a driving force to the first finger module such that the position of the first finger module is changed on the palm module.

5. The robot hand of claim 4, wherein the first actuator module, which is provided on one end of the first finger module in the longitudinal direction, is disposed to face the second actuator module in a horizontal direction,
the first linkage part includes:
a first link in which one end thereof in the longitudinal direction is axially coupled to a lower driving shaft of the second actuator module, and the other end thereof in the longitudinal direction is hinge-coupled to a lower end of the first actuator module; and
a second link in which one end thereof in the longitudinal direction is hinge-coupled to an upper frame of the palm module having the second actuator module provided under the palm module, and the other end thereof in the longitudinal direction is hinge-coupled to an upper end of the first actuator module, and
a hinge shaft, to which the second link and the upper frame are hinge-coupled, and the driving shaft are not coaxially aligned in a vertical direction.

6. The robot hand of claim 1, further comprising a second linkage part,
wherein the second linkage part guides the second finger module to a target position without interfering with the palm module when the position of the second finger module is changed on the palm module.

7. The robot hand of claim 6, further comprising a third actuator module,
wherein the third actuator module is provided on the palm module, and
the third actuator module is connected to the second finger module through the second linkage part to provide a driving force to the second finger module such that the position of the second finger module is changed on the palm module.

8. The robot hand of claim 7, wherein the second linkage part includes:
a third link in which one end thereof in the longitudinal direction is axially coupled to a lower driving shaft of the third actuator module, and the other end thereof in the longitudinal direction is hinge-coupled to a lower end of the first actuator module; and
a fourth link in which one end thereof in the longitudinal direction is hinge-coupled to an upper frame of the palm module having the third actuator module provided under the palm module, and the other end thereof in the longitudinal direction is hinge-coupled to an upper end of the first actuator module, and
a hinge shaft, to which the fourth link and the upper frame are hinge-coupled, and the driving shaft are not coaxially aligned in a vertical direction.

9. The robot hand of claim 1, wherein each of the first to third finger modules includes:
a knuckle part configured to provide an installation space of the first actuator module; and
a fingertip provided at an end of the knuckle part.

10. The robot hand of claim 1, wherein the robot hand is switched to any one of a plurality of operation modes according to change in the positions of the first and second finger modules on the palm module.

11. The robot hand of claim 10, wherein the plurality of operation modes include a left hand mode in which the first finger module serves as a thumb, a right hand mode in which the second finger module serves as a thumb, and a gripper mode in which the first finger module and the second finger module are positioned to face the third finger module.
